(19) United States
(12) Patent Application Publication
(10) Pub. No.: US 2026/0095049 A1
(43) Pub. Date: Apr. 2, 2026

(54) UPDATING AND OPTIMIZATION SYSTEM FOR STATIC SYNCHRONOUS REACTIVE POWER COMPENSATION DEVICE

(71) Applicant: HUANENG SHANSHAN POWER GENERATION CO., LTD., TURPAN (CN)

(72) Inventors: FUQIANG MA, TURPAN (CN); HAO YANG, TURPAN (CN); YINGYING CUI, TURPAN (CN); BIN ZHANG, TURPAN (CN); HAONAN WANG, TURPAN (CN); XIAOYI ZHANG, TURPAN (CN); JUN LI, TURPAN (CN)

(73) Assignee: HUANENG SHANSHAN POWER GENERATION CO., LTD., TURPAN (CN)

(21) Appl. No.: 19/339,466

(22) Filed: Sep. 25, 2025

(30) Foreign Application Priority Data
Sep. 27, 2024 (CN) 202411361333.7

(51) Int. Cl. H02J 3/18

(52) U.S. Cl. CPC H02J 3/18; H02J 2103/30

(57) ABSTRACT

The disclosure relates to the technical field of static synchronous reactive power compensation devices, provides an updating and optimization system for a static synchronous reactive power compensation device. The first module sets multiple contamination detection points on the static synchronous reactive power compensation device, and constructs multiple updating and optimization contamination data chains according to contamination data. The second module constructs a related contamination data set according to the related contamination data, and calculates the sub-update optimization influence coefficients. The third module analyzes and calculates the remaining related pollution data, and constructs sub-update optimization influence coefficient sets. The fourth module sorts the sub-update optimization influence coefficient sets, determines the comprehensive updating optimization influence coefficient set, and calculates the comprehensive updating optimization influence coefficient. The fifth module determines whether to update and optimize the static synchronous reactive power compensation device based on the comprehensive updating optimization influence coefficients.

### CROSS-REFERENCE TO RELATED APPLICATIONS

This application claims priority of Chinese Patent Application No. 202411361333.7, filed on Sep. 27, 2024, the content of which is hereby incorporated by reference.

### TECHNICAL FIELD

The disclosure relates to the technical field of a static synchronous reactive power compensation device, and in particular to an updating and optimization system for a static synchronous reactive power compensation device.

### BACKGROUND

Static synchronous reactive power compensation device is a FACTS (Flexible AC Transmission Systems) device for shunt reactive power compensation, which may emit or absorb reactive power, and has the characteristics of continuously adjustable capacitive or inductive reactive current output, and is not affected by the voltage of the system connection point. Static synchronous reactive power compensation device has become an indispensable part of modern power system because of its advanced technical principle, excellent performance characteristics, wide application fields and remarkable social benefits. With the continuous progress of technology and the continuous growth of power market demand, the static synchronous reactive power compensation device will play a greater role in improving the power quality, stability and economic benefits of the power grid.

However, the traditional static synchronous reactive power compensation device may encounter some problems in the operation process: with the development of power system, the requirements for the stability and reliability of power grid are getting higher and higher, especially in long-distance transmission, new energy grid connection and large industrial load fluctuation, the role of static synchronous reactive power compensation device is particularly important. However, with the passage of time and the progress of technology, the original equipment may not meet the current operation requirements, or the performance may be degraded due to long-term operation, which requires updating and optimization. However, for the updating and optimization of the static synchronous reactive power compensation device, the relevant staff also need to judge according to their work experience, which is prone to judgment errors and problems such as premature or untimely updating of the static synchronous reactive power compensation device.

### SUMMARY

The embodiment of the disclosure provides an updating and optimization system for a static synchronous reactive power compensation device, which may accurately update and optimize the static synchronous reactive power compensation device, effectively improve the operating environment of equipment, have high reliability and meet the requirements of long-term stable operation of equipment.

In order to achieve the above objectives, the disclosure provides an updating optimization system for a static synchronous reactive power compensation device, which includes:
a first module, configured for determining a static synchronous reactive power compensation device, setting multiple contamination detection points on the static synchronous reactive power compensation device device, obtaining contamination data of each of the contamination detection points, and constructing multiple updating and optimization contamination data chains according to all contamination data;
a second module, configured for constructing a related contamination data set according to related contamination data on each of the updating and optimization contamination data chains, analyzing the related contamination data set, and calculating corresponding one of sub-update optimization influence coefficients based on analysis results;
a third module, configured for analyzing and calculating remaining related contamination data on the updating and optimization contamination data chains, determining corresponding one of the sub-update optimization influence coefficients, and constructing sub-update optimization influence coefficient sets according to all the sub-update optimization influence coefficients;
a fourth module, configured for sorting the sub-update optimization influence coefficient sets, determining a comprehensive updating optimization influence coefficient set based on sorting results, and calculating comprehensive updating optimization influence coefficients of the static synchronous reactive power compensation device according to the comprehensive updating optimization influence coefficient set; and
a fifth module, configured for determining whether to update and optimize the static synchronous reactive power compensation device based on the comprehensive updating optimization influence coefficients.

Further, the first module is configured for:
outputting a contamination data entropy value of corresponding to each contamination data based on a pre-trained data entropy value model;
obtaining a preset contamination data entropy value, and generating upper-chain labels for all contamination data greater than or equal to the preset contamination data entropy value;
generating lower-chain labels for all contamination data smaller than the preset contamination data entropy value;
determining a maximum contamination data entropy value and a minimum contamination data entropy value according to contamination data entropy values carrying lower-chain labels, and calculating a contamination data entropy value difference value between the maximum contamination data entropy value and the minimum contamination data entropy value;
obtaining a preset contamination data entropy value difference value, and if the contamination data entropy value is smaller than the preset contamination data entropy value difference value, constructing the updating and optimization contamination data chains according to all contamination data; and
constructing the updating and optimization contamination data chains according to contamination data carrying the upper-chain labels if the contamination data entropy value difference value is greater than or equal to the preset contamination data entropy value difference value.

Further, the first module is configured for:
collecting a training data set, where the training data set includes multiple samples, and each of the samples has multiple features;
calculating entropy values of features of each of the samples to evaluate information content of the features;
sorting the features according to calculated entropy values, and selecting a predetermined number of features with high entropy values as input of the model;
training an initial data entropy value model by using selected features and corresponding sample labels;
evaluating performance of the initial model through a cross-validation method; and
outputting a finally trained data entropy value model if the performance of the initial model reaches a preset standard.

Further, the second module is configured for:
determining a contamination data range corresponding to the related contamination data set, where the contamination data range includes a first preset contamination data value and a second preset contamination data value;
dividing contamination data in the related contamination data set of being less than or equal to the first preset contamination data value into a first data sequence;
dividing contamination data in the related contamination data set of being larger than the first preset contamination data value and smaller than the second preset contamination data value into a second data sequence; and
dividing contamination data in the related contamination data set of being greater than or equal to the second preset contamination data value into a third data sequence.

Further, the second module is configured for:
calculating a first average value and a first standard deviation of the first data sequence, and calculating a first numerical processing range of the first data sequence according to the first average value and the first standard deviation;
calculating the first numerical processing range of the first data sequence according to a following formula:

$$k ( k 1 , k 2 ) = ( b 1 \times f 1 ) \pm ( b 2 \times f 2 ) ;$$

where, k(k1, k2) is the first numerical processing range, k1 is a left boundary value, k2 is a right boundary value, b1 is a calculation coefficient corresponding to the first average value, f1 is the first average value, b2 is a calculation coefficient corresponding to the first standard deviation, and f2 is the first standard deviation;
calculating a second average value and a second standard deviation of the second data sequence, and calculating a second numerical processing range of the second data sequence according to the second average value and the second standard deviation;
calculating a third average value and a third standard deviation of the third data sequence, and calculating a third numerical processing range of the third data sequence according to the third average value and the third standard deviation;
comparing contamination data in each data sequence with a corresponding numerical processing range, generating internal association codes for the contamination data if the contamination data is within the corresponding numerical processing range, and generating external association codes for the contamination data if the contamination data is not within the corresponding numerical processing range; and
calculating the sub-update optimization influence coefficients according to the internal association codes.

Further, the second module is configured for:
generating a first factor for the first data sequence, a second factor for the second data sequence and a third factor for the third data sequence; and
calculating the sub-update optimization influence coefficients according to a following formula:

$$w = p 1 \times m 1 + p 2 \times m 2 + p 3 \times m 3 ;$$

where, w is a sub-update optimization influence coefficient, p1 is the first factor, m1 is a number of internal association codes in the first data sequence, p2 is the second factor, m2 is a number of internal association codes in the second data sequence, p3 is the third factor, and m3 is a number of internal association codes in the third data sequence.

Further, the fourth module is configured for:
determining a median and a variance of each of the sub-update optimization influence coefficient sets;
extracting sub-update optimization influence coefficients of being greater than the median in the sub-update optimization influence coefficient sets, and constructing a first coefficient set;
extracting sub-updated optimization influence coefficients of being greater than the variance in the sub-update optimization influence coefficient sets, and constructing a second coefficient set;
determining whether there is an intersection between the first coefficient set and the second coefficient set;
constructing the comprehensive updating optimization influence coefficient set according to an intersection value if yes; and
performing non-repetitive fusion on the first coefficient set and the second coefficient set if not, constructing the comprehensive updating optimization influence coefficient set, where the non-repetitive fusion is to keep non-repetitive sub-update optimization influence coefficients in the first coefficient set and the second coefficient set, keep one repetitive sub-update optimization influence coefficient in the first coefficient set and the second coefficient set, and delete remaining repetitive sub-update optimization influence coefficients.

Further, the fourth module is configured for:
calculating the comprehensive updating optimization influence coefficients of the static synchronous reactive power compensation device according to a following formula:

$$R = \frac{ln ( 1 + {\sum }_{i = 1}^{n} ( Δ {t}_{i} \times \frac{{t}_{i} - {t}_{min}}{{t}_{max}^{2} - {t}_{i}^{2}} ) )}{\frac{1}{n} \times ( 1 + {( {t}_{max}^{2} - {t}_{i}^{2} )}_{max} )} ;$$

where, R is a comprehensive updating optimization influence coefficient of the static synchronous reactive power compensation device, n is a number of the sub-update optimization influence coefficients in the comprehensive updating optimization influence coefficient set, Δtᵢ is weight corresponding to an i-th sub-update optimization influence coefficient, tᵢ is the i-th sub-update optimization influence coefficient, tₘᵢₙ is a smallest sub-update optimization influence coefficient, and tₘₐₓ is a largest sub-update optimization influence coefficient,

$${( {t}_{max}^{2} - {t}_{i}^{2} )}_{max}$$

is a maximum value of all

$${t}_{max}^{2} - {t}_{i}^{2} .$$

Further, the fifth module is configured for:
obtaining a preset comprehensive updating optimization influence coefficient;
determining not to update and optimize the static synchronous reactive power compensation device when the comprehensive updating optimization influence coefficient is smaller than the preset comprehensive updating optimization influence coefficient; and
determining to update and optimize the static synchronous reactive power compensation device when the comprehensive updating optimization influence coefficient is greater than or equal to the preset comprehensive updating optimization influence coefficient.

Compared with the prior art, the disclosure has the following beneficial effects.

The first module sets multiple contamination detection points on the static synchronous reactive power compensation device, and constructs multiple updating and optimization contamination data chains according to contamination data. The second module constructs a related contamination data set according to the related contamination data, and calculates the sub-update optimization influence coefficients. The third module analyzes and calculates the remaining related pollution data, and constructs sub-update optimization influence coefficient sets. The fourth module sorts the sub-update optimization influence coefficient sets, determines the comprehensive updating optimization influence coefficient set, and calculates the comprehensive updating optimization influence coefficient. The fifth module determines whether to update and optimize the static synchronous reactive power compensation device based on the comprehensive updating optimization influence coefficients, which can accurately update and optimize the static synchronous reactive power compensation device, the operating environment of the equipment is effectively improved, the system has high reliability and may meet the requirements of long-term stable operation of equipment.

### BRIEF DESCRIPTION OF THE DRAWINGS

Various other advantages and benefits will become apparent to those skilled in the art by reading the following detailed description of preferred embodiments. The drawings are only for the purpose of illustrating the preferred embodiment, and are not considered as limiting the disclosure. Moreover, like parts are denoted by like reference characters throughout the drawings. In the attached drawings:

FIG. 1 is a schematic structural diagram of an updating and optimization system for a static synchronous reactive power compensation device according to embodiments of the disclosure.

### DETAILED DESCRIPTION OF THE EMBODIMENTS

In the following, the specific embodiments of the disclosure will be described in further detail with the attached drawings and embodiments. The following embodiments are used to illustrate the disclosure, but are not intended to limit the scope of the disclosure.

In the description of the disclosure, it should be understood that the azimuth or positional relationship indicated by the terms “center”, “up”, “down”, “front”, “back”, “left”, “right”, “vertical”, “horizontal”, “top”, “bottom”, “inside” and “outside” is based on the azimuth or positional relationship shown in the attached drawings, only for the convenience of describing this disclosure and simplifying the description, and may not indicate or imply that the referred device or element must have a specific orientation, be constructed and operated in a specific orientation, so it may not be understood as a limitation of this disclosure.

The terms “first” and “second” are only used for descriptive purposes, and may not be understood as indicating or implying relative importance or implicitly indicating the number of indicated technical features. Therefore, the features defined as “first” and “second” may include one or more of these features explicitly or implicitly. In the description of this disclosure, unless otherwise specified, “multiple” means two or more.

In the description of this disclosure, it should be noted that unless otherwise specified and limited, the terms “installation”, “connecting” and “connection” should be broadly understood, for example, a fixed connection may be, a detachable connection or integrated connection may be; a mechanical connection or an electrical connection may also be; a direct connection may be, an indirect connection through an intermediate medium may also be, and a connection inside two elements may also be. For those skilled in the art, the specific meanings of the above terms in this disclosure may be understood in specific circumstances.

The following is a description of preferred embodiments of the disclosure with reference to the accompanying drawings.

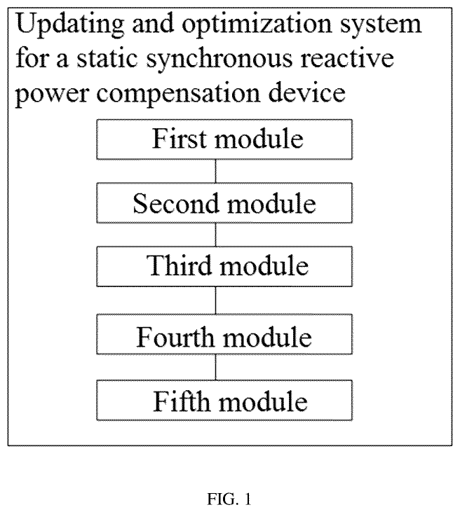

As shown in FIG. 1, an embodiment of the disclosure provides an updating and optimization system for a static synchronous reactive power compensation device, which includes:
a first module, configured for determining a static synchronous reactive power compensation device, setting multiple contamination detection points on the static synchronous reactive power compensation device device, obtaining contamination data of each of the contamination detection points, and constructing multiple updating and optimization contamination data chains according to all contamination data;
a second module, configured for constructing a related contamination data set according to related contamination data on each of the updating and optimization contamination data chains, analyzing the related contamination data set, and calculating corresponding one of sub-update optimization influence coefficients based on analysis results;
a third module, configured for analyzing and calculating remaining related contamination data on the updating and optimization contamination data chains, determining corresponding one of the sub-update optimization influence coefficients, and constructing sub-update optimization influence coefficient sets according to all the sub-update optimization influence coefficients;
a fourth module, configured for sorting the sub-update optimization influence coefficient sets, determining a comprehensive updating optimization influence coefficient set based on sorting results, and calculating comprehensive updating optimization influence coefficients of the static synchronous reactive power compensation device according to the comprehensive updating optimization influence coefficient set; and
a fifth module, configured for determining whether to update and optimize the static synchronous reactive power compensation device based on the comprehensive updating optimization influence coefficients.

In this embodiment, the contamination data include the amount of ash deposition, the degree of corrosion, the degree of liquid deterioration, the degree of wear, the amount of pollutant deposition, and the like.

The above technical scheme has the following beneficial effects: the disclosure may accurately update and optimize the static synchronous reactive power compensation device, effectively improve the operating environment of the equipment, has high reliability, and may meet the requirements of long-term stable operation of the equipment.

In some embodiments of the disclosure, the first module is configured for:
outputting a contamination data entropy value of corresponding to each contamination data based on a pre-trained data entropy value model;
obtaining a preset contamination data entropy value, and generating upper-chain labels for all contamination data greater than or equal to the preset contamination data entropy value;
generating lower-chain labels for all contamination data smaller than the preset contamination data entropy value;
determining a maximum contamination data entropy value and a minimum contamination data entropy value according to contamination data entropy values carrying lower-chain labels, and calculating a contamination data entropy value difference value between the maximum contamination data entropy value and the minimum contamination data entropy value;
obtaining a preset contamination data entropy value difference value, and if the contamination data entropy value is smaller than the preset contamination data entropy value difference value, constructing the updating and optimization contamination data chains according to all contamination data; and
constructing the updating and optimization contamination data chains according to contamination data carrying the upper-chain labels if the contamination data entropy value difference value is greater than or equal to the preset contamination data entropy value difference value.

The above technical scheme has the following beneficial effects: the disclosure may lay a foundation for updating and optimizing the static synchronous reactive power compensation device by constructing the updating and optimization contamination data chains.

In some embodiments of the disclosure, the first module is configured for:
collecting a training data set, where the training data set includes multiple samples, and each of the samples has multiple features;
calculating entropy values of features of each of the samples to evaluate information content of the features;
sorting the features according to calculated entropy values, and selecting a predetermined number of features with high entropy values as input of the model;
training an initial data entropy value model by using selected features and corresponding sample labels;
evaluating performance of the initial model through a cross-validation method; and
outputting a finally trained data entropy value model if the performance of the initial model reaches a preset standard.

In this embodiment, the entropy value of the features of each of the samples is calculated according to the following formula:

$$E ( X ) = - {\sum }_{i = 1}^{n} p ( {x}_{i} ) log p ( {x}_{i} )$$

where, E(X) is the entropy value of feature X, p(xᵢ) is the probability of the i-th value in feature X, and n is the number of different values in feature X.

The above technical scheme has the following beneficial effects: by training the data entropy model, the disclosure may accurately output the data entropy value of each contaminated data, so as to avoid errors and subsequent judgment errors.

In some embodiments of the disclosure, the second module is configured for:
determining a contamination data range corresponding to the related contamination data set, where the contamination data range includes a first preset contamination data value and a second preset contamination data value;
dividing contamination data in the related contamination data set of being less than or equal to the first preset contamination data value into a first data sequence;
dividing contamination data in the related contamination data set of being larger than the first preset contamination data value and smaller than the second preset contamination data value into a second data sequence; and
dividing contamination data in the related contamination data set of being greater than or equal to the second preset contamination data value into a third data sequence.

In this embodiment, the related contamination data refers to the same type of contamination data.

In this embodiment, the contamination data range corresponding to each contamination data is different, which may be set according to the actual situation, and the first preset contamination data value is smaller than the second preset contamination data value.

The above technical scheme has the following beneficial effects: the disclosure divides the contamination data into the first data sequence, the second data sequence and the third data sequence according to the contamination data range, which may provide reliable data support for the calculation of the sub-update optimization influence coefficients.

In some embodiments of the disclosure, the second module is configured for:
calculating a first average value and a first standard deviation of the first data sequence, and calculating a first numerical processing range of the first data sequence according to the first average value and the first standard deviation;
calculating the first numerical processing range of the first data sequence according to a following formula:

$$k ( k 1 , k 2 ) = ( b 1 \times f 1 ) \pm ( b 2 \times f 2 ) ;$$

where, k(k1, k2) is the first numerical processing range, k1 is a left boundary value, k2 is a right boundary value, b1 is a calculation coefficient corresponding to the first average value, f1 is the first average value, b2 is a calculation coefficient corresponding to the first standard deviation, and f2 is the first standard deviation;
calculating a second average value and a second standard deviation of the second data sequence, and calculating a second numerical processing range of the second data sequence according to the second average value and the second standard deviation;
calculating a third average value and a third standard deviation of the third data sequence, and calculating a third numerical processing range of the third data sequence according to the third average value and the third standard deviation;
comparing contamination data in each data sequence with a corresponding numerical processing range, generating internal association codes for the contamination data if the contamination data is within the corresponding numerical processing range, and generating external association codes for the contamination data if the contamination data is not within the corresponding numerical processing range; and
calculating the sub-update optimization influence coefficients according to the internal association codes.

In this embodiment, the second numerical processing range and the third numerical processing range are consistent with the calculation process of the first numerical processing range, and are not defined repeatedly in order to save space.

The above technical scheme has the following beneficial effects: the sub-update optimization influence coefficients are calculated according to the internal association codes, so that the comprehensiveness and accuracy of the calculation of the sub-update optimization influence coefficients may be ensured, and the errors existing in manual participation may be avoided.

In some embodiments of the disclosure, the second module is configured for:
generating a first factor for the first data sequence, a second factor for the second data sequence and a third factor for the third data sequence; and
calculating the sub-update optimization influence coefficients according to a following formula:

$$w = p 1 \times m 1 + p 2 \times m 2 + p 3 \times m 3 ;$$

where, w is a sub-update optimization influence coefficient, p1 is the first factor, m1 is a number of internal association codes in the first data sequence, p2 is the second factor, m2 is a number of internal association codes in the second data sequence, p3 is the third factor, and m3 is a number of internal association codes in the third data sequence.

In this embodiment, the first factor is 0.2, the second factor is 0.4 and the third factor is 0.8.

In some embodiments of the disclosure, the fourth module is configured for:
determining a median and a variance of each of the sub-update optimization influence coefficient sets;
extracting sub-update optimization influence coefficients of being greater than the median in the sub-update optimization influence coefficient sets, and constructing a first coefficient set;
extracting sub-updated optimization influence coefficients of being greater than the variance in the sub-update optimization influence coefficient sets, and constructing a second coefficient set;
determining whether there is an intersection between the first coefficient set and the second coefficient set;
constructing the comprehensive updating optimization influence coefficient set according to an intersection value if yes; and
performing non-repetitive fusion on the first coefficient set and the second coefficient set if not, constructing the comprehensive updating optimization influence coefficient set, where the non-repetitive fusion is to keep non-repetitive sub-update optimization influence coefficients in the first coefficient set and the second coefficient set, keep one repetitive sub-update optimization influence coefficient in the first coefficient set and the second coefficient set, and delete remaining repetitive sub-update optimization influence coefficients.

In this embodiment, if the sub-update optimization influence coefficients in the first coefficient set are 4, 4, 5, 7, 8 and 9, and the sub-update optimization influence coefficients in the second coefficient set are 5, 7, 8 and 9, there is an intersection, and the comprehensive update optimization influence coefficient set is 4, 4, 5, 7, 8, 9, 5 and 7. If the sub-update optimization influence coefficients in the first coefficient set are 3, 3, 5 and 7, and the sub-update optimization influence coefficients in the second coefficient set are 8, 8 and 9, there is no intersection, and the comprehensive update optimization influence coefficient set is 3, 5, 7, 8 and 9, which are shown by way of example and are not specifically limited.

The above technical scheme has the following beneficial effects: the comprehensive update optimization influence coefficient set is constructed, and then the comprehensive update optimization influence coefficient is calculated according to the comprehensive update optimization influence coefficient set, which may provide a basis for judging the update optimization, rather than judging according to the working experience of the staff, thus avoiding subjectivity.

In some embodiments of the disclosure, the fifth module is configured for:
obtaining a preset comprehensive updating optimization influence coefficient;
determining not to update and optimize the static synchronous reactive power compensation device when the comprehensive updating optimization influence coefficient is smaller than the preset comprehensive updating optimization influence coefficient; and
determining to update and optimize the static synchronous reactive power compensation device when the comprehensive updating optimization influence coefficient is greater than or equal to the preset comprehensive updating optimization influence coefficient.

The technical scheme has the following beneficial effects: the disclosure determines whether to update and optimize the static synchronous reactive power compensation device based on the comprehensive update optimization influence coefficient, which may not only ensure the timely update and optimization of the static synchronous reactive power compensation device, but also avoid the problem of wasting devices by updating and optimizing in advance.

In the description of the above embodiments, specific features, structures, materials or characteristics may be combined in any one or more embodiments or examples in a suitable way.

Although the disclosure has been described above with reference to embodiments, various improvements may be made thereto and equivalents may be substituted for parts thereof without departing from the scope of the disclosure. In particular, as long as there is no structural conflict, all the features in the disclosed embodiments of the disclosure may be combined with each other in any way, and all these combinations are not described in this specification only for the sake of omitting space and saving resources.

It may be understood by those skilled in the art: the above is only the preferred embodiment of the disclosure, and it is not used to limit the disclosure. Although the disclosure has been described in detail with reference to the foregoing embodiments, it is still possible for those skilled in the art to modify the technical schemes recorded in the foregoing embodiments or to replace some technical features equally. Any modification, equivalent substitution, improvement, etc. made within the spirit and principle of the disclosure should be included in the protection scope of the disclosure.

What is claimed is:

1. An updating and optimization system for a static synchronous reactive power compensation device, comprising:
a first module, configured for determining a static synchronous reactive power compensation device, setting a plurality of contamination detection points on the static synchronous reactive power compensation device device, obtaining contamination data of each of the contamination detection points, and constructing a plurality of updating and optimization contamination data chains according to all contamination data;
a second module, configured for constructing a related contamination data set according to related contamination data on each of the updating and optimization contamination data chains, analyzing the related contamination data set, and calculating corresponding one of sub-update optimization influence coefficients based on analysis results;
a third module, configured for analyzing and calculating remaining related contamination data on the updating and optimization contamination data chains, determining corresponding one of the sub-update optimization influence coefficients, and constructing sub-update optimization influence coefficient sets according to all the sub-update optimization influence coefficients;
a fourth module, configured for sorting the sub-update optimization influence coefficient sets, determining a comprehensive updating optimization influence coefficient set based on sorting results, and calculating comprehensive updating optimization influence coefficients of the static synchronous reactive power compensation device according to the comprehensive updating optimization influence coefficient set; and
a fifth module, configured for determining whether to update and optimize the static synchronous reactive power compensation device based on the comprehensive updating optimization influence coefficients.

2. The updating and optimization system for a static synchronous reactive power compensation device according to claim 1, wherein the first module is configured for:
outputting a contamination data entropy value of corresponding to each contamination data based on a pre-trained data entropy value model;
obtaining a preset contamination data entropy value, and generating upper-chain labels for all contamination data greater than or equal to the preset contamination data entropy value;
generating lower-chain labels for all contamination data smaller than the preset contamination data entropy value;
determining a maximum contamination data entropy value and a minimum contamination data entropy value according to contamination data entropy values carrying lower-chain labels, and calculating a contamination data entropy value difference value between the maximum contamination data entropy value and the minimum contamination data entropy value;
obtaining a preset contamination data entropy value difference value, and if the contamination data entropy value is smaller than the preset contamination data entropy value difference value, constructing the updating and optimization contamination data chains according to all contamination data; and
constructing the updating and optimization contamination data chains according to contamination data carrying the upper-chain labels if the contamination data entropy value difference value is greater than or equal to the preset contamination data entropy value difference value.

3. The updating and optimization system for a static synchronous reactive power compensation device according to claim 2, wherein the first module is configured for:
collecting a training data set, wherein the training data set comprises a plurality of samples, and each of the samples has a plurality of features;
calculating entropy values of features of each of the samples to evaluate information content of the features;
sorting the features according to calculated entropy values, and selecting a predetermined number of features with high entropy values as input of the model;
training an initial data entropy value model by using selected features and corresponding sample labels;
evaluating performance of the initial model through a cross-validation method; and
outputting a finally trained data entropy value model if the performance of the initial model reaches a preset standard.

4. The updating and optimization system for a static synchronous reactive power compensation device according to claim 1, wherein the second module is configured for:
determining a contamination data range corresponding to the related contamination data set, wherein the contamination data range comprises a first preset contamination data value and a second preset contamination data value;
dividing contamination data in the related contamination data set of being less than or equal to the first preset contamination data value into a first data sequence;
dividing contamination data in the related contamination data set of being larger than the first preset contamination data value and smaller than the second preset contamination data value into a second data sequence; and
dividing contamination data in the related contamination data set of being greater than or equal to the second preset contamination data value into a third data sequence.

5. The updating and optimization system for a static synchronous reactive power compensation device according to claim 4, wherein the second module is configured for:
calculating a first average value and a first standard deviation of the first data sequence, and calculating a first numerical processing range of the first data sequence according to the first average value and the first standard deviation;
calculating the first numerical processing range of the first data sequence according to a following formula:
$$k ( k 1 , k 2 ) = ( b 1 \times f 1 ) \pm ( b 2 \times f 2 ) ;$$
wherein, k(k1, k2) is the first numerical processing range, k1 is a left boundary value, k2 is a right boundary value, b1 is a calculation coefficient corresponding to the first average value, f1 is the first average value, b2 is a calculation coefficient corresponding to the first standard deviation, and f2 is the first standard deviation;
calculating a second average value and a second standard deviation of the second data sequence, and calculating a second numerical processing range of the second data sequence according to the second average value and the second standard deviation;
calculating a third average value and a third standard deviation of the third data sequence, and calculating a third numerical processing range of the third data sequence according to the third average value and the third standard deviation;
comparing contamination data in each data sequence with a corresponding numerical processing range, generating internal association codes for the contamination data if the contamination data is within the corresponding numerical processing range, and generating external association codes for the contamination data if the contamination data is not within the corresponding numerical processing range; and
calculating the sub-update optimization influence coefficients according to the internal association codes.

6. The updating and optimization system for a static synchronous reactive power compensation device according to claim 5, wherein the second module is configured for:
generating a first factor for the first data sequence, a second factor for the second data sequence and a third factor for the third data sequence; and
calculating the sub-update optimization influence coefficients according to a following formula:
$$w = p 1 \times m 1 + p 2 \times m 2 + p 3 \times m 3 ;$$
wherein, w is a sub-update optimization influence coefficient, p1 is the first factor, m1 is a number of internal association codes in the first data sequence, p2 is the second factor, m2 is a number of internal association codes in the second data sequence, p3 is the third factor, and m3 is a number of internal association codes in the third data sequence.

7. The updating and optimization system for a static synchronous reactive power compensation device according to claim 1, wherein the fourth module is configured for:
determining a median and a variance of each of the sub-update optimization influence coefficient sets;
extracting sub-update optimization influence coefficients of being greater than the median in the sub-update optimization influence coefficient sets, and constructing a first coefficient set;
extracting sub-updated optimization influence coefficients of being greater than the variance in the sub-update optimization influence coefficient sets, and constructing a second coefficient set;
determining whether there is an intersection between the first coefficient set and the second coefficient set;
constructing the comprehensive updating optimization influence coefficient set according to an intersection value if yes; and
performing non-repetitive fusion on the first coefficient set and the second coefficient set if not, constructing the comprehensive updating optimization influence coefficient set, wherein the non-repetitive fusion is to keep non-repetitive sub-update optimization influence coefficients in the first coefficient set and the second coefficient set, keep one repetitive sub-update optimization influence coefficient in the first coefficient set and the second coefficient set, and delete remaining repetitive sub-update optimization influence coefficients.

8. The updating and optimization system for a static synchronous reactive power compensation device according to claim 7, wherein the fourth module is configured for:
calculating the comprehensive updating optimization influence coefficients of the static synchronous reactive power compensation device according to a following formula;
$$R = \frac{ln ( 1 + {\sum }_{i = 1}^{n} ( Δ {t}_{i} \times \frac{{t}_{i} - {t}_{min}}{{t}_{max}^{2} - {t}_{i}^{2}} ) )}{\frac{1}{n} \times ( 1 + {( {t}_{max}^{2} - {t}_{i}^{2} )}_{max} )} ;$$
wherein, R is a comprehensive updating optimization influence coefficient of the static synchronous reactive power compensation device, n is a number of the sub-update optimization influence coefficients in the comprehensive updating optimization influence coefficient set, Δtᵢ is weight corresponding to an i-th sub-update optimization influence coefficient, tᵢ is the i-th sub-update optimization influence coefficient, tₘᵢₙ is a smallest sub-update optimization influence coefficient, and tₘₐₓ is a largest sub-update optimization influence coefficient,
$${( {t}_{max}^{2} - {t}_{i}^{2} )}_{max}$$
is a maximum value of all
$${t}_{max}^{2} - {t}_{i}^{2} .$$

9. The updating and optimization system for a static synchronous reactive power compensation device according to claim 1, wherein the fifth module is configured for:
obtaining a preset comprehensive updating optimization influence coefficient;
determining not to update and optimize the static synchronous reactive power compensation device when the comprehensive updating optimization influence coefficient is smaller than the preset comprehensive updating optimization influence coefficient; and
determining to update and optimize the static synchronous reactive power compensation device when the comprehensive updating optimization influence coefficient is greater than or equal to the preset comprehensive updating optimization influence coefficient.
